(19) United States
(12) Patent Application Publication
(10) Pub. No.: US 2008/0263889 A1
(43) Pub. Date: Oct. 30, 2008

(54) Hand Drying Apparatus

(75) Inventors: Yoshihiro Fukaya, Tokyo (JP); Syunichi Mori, Tokyo (JP); Yasuyuki Itoigawa, Tokyo (JP)

Correspondence Address: BUCHANAN, INGERSOLL & ROONEY PC, POST OFFICE BOX 1404, ALEXANDRIA, VA, 22313-1404, US

(73) Assignee: MITSUBISHI ELECTRIC CORPORATION, TOKYO (JP)

(21) Appl. No.: 11/884,122

(22) PCT Filed: Jul. 26, 2005
(86) PCT No.: PCT/JP2005/013652

§ 371 Date: Aug. 10, 2007

(51) Int. Cl. F26B 3/34; F26B 21/00; F26B 19/00; F26B 25/06

(52) U.S. Cl. 34/267; 34/565; 34/572; 34/202

(57) ABSTRACT

In a hand drying apparatus, an infrared light absorber absorbs infrared light, when a hand is not present, emitted from an infrared light emitter provided on an inner surface of a drying space.

### TECHNICAL FIELD

The present invention relates to a hand drying apparatus that hygienically dries wet hands after washing, and more particularly to a hand drying apparatus that can prevent improper operations with a high accuracy, when a person approaches to the dryer.

### BACKGROUND ART

As an apparatus that dries wet hands after washing, there are hand drying apparatus that blow away water on hands to dry the hands using fast airflow. The hand drying apparatus have a box formed with a hand insertion portion in a recessed shape as a hand drying space, and air nozzles are arranged on the hand insertion portion. The air nozzles are connected with an air duct, connected to a high pressure airflow generator, thereby discharging fast airflow in the hand insertion portion. Water is blown away in the hand drying space by the hand drying, and the water drops from a water drain port provided on a bottom of the hand insertion portion to a drain container provided below the hand insertion portion to be received in the container.

The hand drying apparatus are often constituted such that a hand detector constituted of an infrared light emitter and an infrared light receiver is provided on a wall face that forms the hand drying space. When insertion of hands into the hand drying space is detected by the hand detector, fast airflow is discharged based on a detection signal from the hand detector.

As an arrangement system for the infrared light emitter and the infrared light receiver, there is a detection system of a transmission type where the infrared light emitter and the infrared light receiver are respectively arranged on, for example, a front side wall face and a rear side wall face forming the hand drying space so as to be opposed to each other, and presence of hands is detected based on whether light to the receiver is interrupted. In the detecting system of the transmission type, however, since the infrared light emitter and the infrared light receiver are arranged at different positions, the structure of a main unit of the detecting system is complicated, which causes such a problem as increase in pressure loss in an air duct, or increase in cost of the main unit.

Patent document 1 discloses a hand detector of a reflected light detection type where an infrared light emitter and an infrared light receiver that detect hands inserted into a hand drying space are arranged on the same wall face. In the Patent document 1, such a constitution is employed that the infrared light emitter and the infrared light receiver provided on the same wall face are obliquely aimed on a position below and inside an air outlet, so that a hand detecting range is limited and improper operations are prevented even if a person other than a user of the hand drying apparatus approaches to its main unit.

Patent Document 1: Japanese Patent Application Laid-open No. H11-318760

### DISCLOSURE OF INVENTION

### Problem to be Solved by the Invention

However, in the conventional hand drying apparatus disclosed in the Patent document 1, since reflection of infrared lights from the wall face forming the drying space is not particularly taken into consideration, infrared lights leaving outside from the main unit due to diffuse reflection thereof on the wall face forming the drying space increase, which results in a high possibility that, when a person other than a user of the hand drying apparatus approaches to the main unit, an improper operation occurs such that the light receiver detects the person and starts a drying operation.

In the Patent document 1, although a reference value for comparison with a received light intensity is set higher than a value obtained when a person approaches to the main unit, to prevent improper operations that can occur when a person approach around the main unit. However, a detection range of hands is reduced to be narrow by setting of the reference value for comparison with a received light intensity to be higher.

The present invention has been made in view of the above, and has an object to provide a hand drying apparatus in which improper operations can be prevented with a high accuracy when a person other than a user comes near the apparatus and that makes it possible to achieve a wide hand detection range.

### Means for Solving Problem

To solve the above problems and to achieve the objects, according to an aspect of the present invention, a hand drying apparatus includes a high pressure airflow generator configured to generate high pressure airflow; a nozzle that discharges the high pressure airflow generated by the high pressure airflow generator; a drying space forming unit that has a hand insertion portion that allows insertion and pulling-out of hands and is formed with a drying space where hands inserted through the hand insertion portion is dried by the high pressure airflow discharged from the nozzle; and at least one hand detector constituted of an infrared light emitter and an infrared light receiver for detecting hands inserted into the drying space that are arranged on the same wall face of the drying space forming unit, wherein driving of the high pressure airflow generator is controlled based on a detection signal from the hand detector, and an infrared light absorber whose infrared light reflectivity is smaller than that of hands and absorbs infrared lights is formed on at least a portion of the wall face of the drying space forming unit that is opposed to the infrared light emitter of the hand detector.

### Effect of the Invention

According to the present invention, since the infrared light absorber whose infrared light reflectivity is smaller than that of hands and that absorbs infrared lights is formed on the wall face opposed to the infrared light emitter in the dry space forming unit, infrared lights emitted from the infrared light emitter are substantially absorbed in the infrared absorber, so that improper operations due to diffuse reflection of infrared lights when a person other than a user of the hand drying apparatus approaches to the main unit can be prevented with a high accuracy. Since it is unnecessary to make the hand detection range narrow, which is different from the conventional technique, the hand drying apparatus according to the present invention can be used comfortably without stopping the operation thereof during its use.

### BRIEF DESCRIPTION OF DRAWINGS

FIG. 1 is a right side cross-section of a hand drying apparatus according to a first embodiment;

FIG. 2 is a schematic diagram of the hand drying apparatus according to the first embodiment;

FIG. 3 is a schematic diagram of the hand drying apparatus according to the first embodiment;

FIG. 4 is a right side cross-section of a variant of the hand drying apparatus according to the first embodiment; and

FIG. 5 is a right side cross-section of a hand drying apparatus according to a second embodiment.

### EXPLANATIONS OF LETTERS OR NUMERALS

1 Main unit box member
2 High pressure airflow generator
3 Hand insertion portion
4 Air nozzle
5 Base
6 Drying space
7 Front panel
8 Hand detector
9 Infrared ray emitter
10 Infrared ray absorber
12 Drain port
13 Drainage pipe
14 Drain container
15 Air filter
16 Air duct
18 Air intake port
19 Infrared ray receiver
20 Infrared ray emitter
21 Hand

### BEST MODE(S) FOR CARRYING OUT THE INVENTION

Exemplary embodiments of a hand drying apparatus according to the present invention will be explained below with reference to the accompanying drawings. Note that the invention is not limited by the embodiments.

### FIRST EMBODIMENT

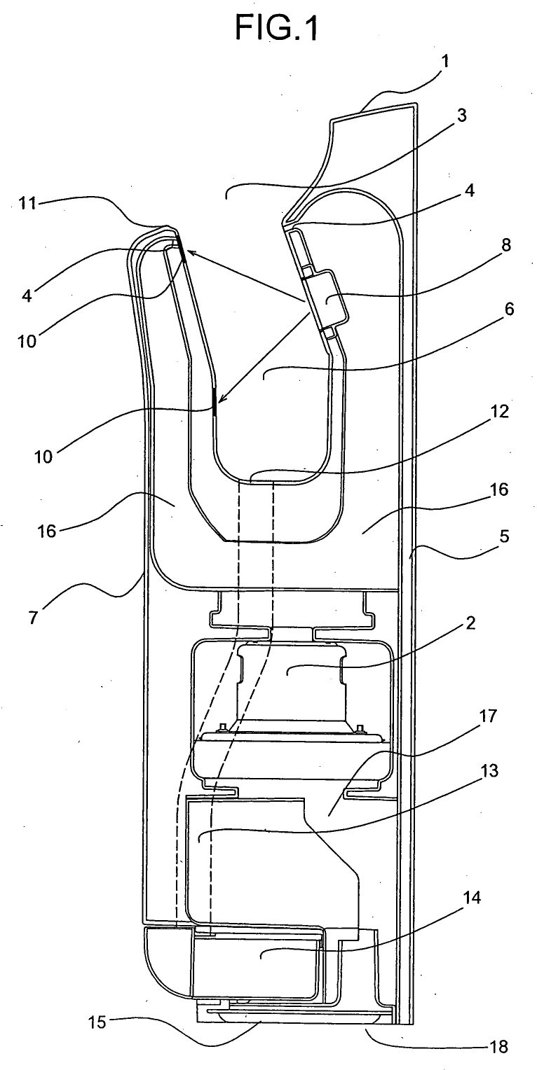

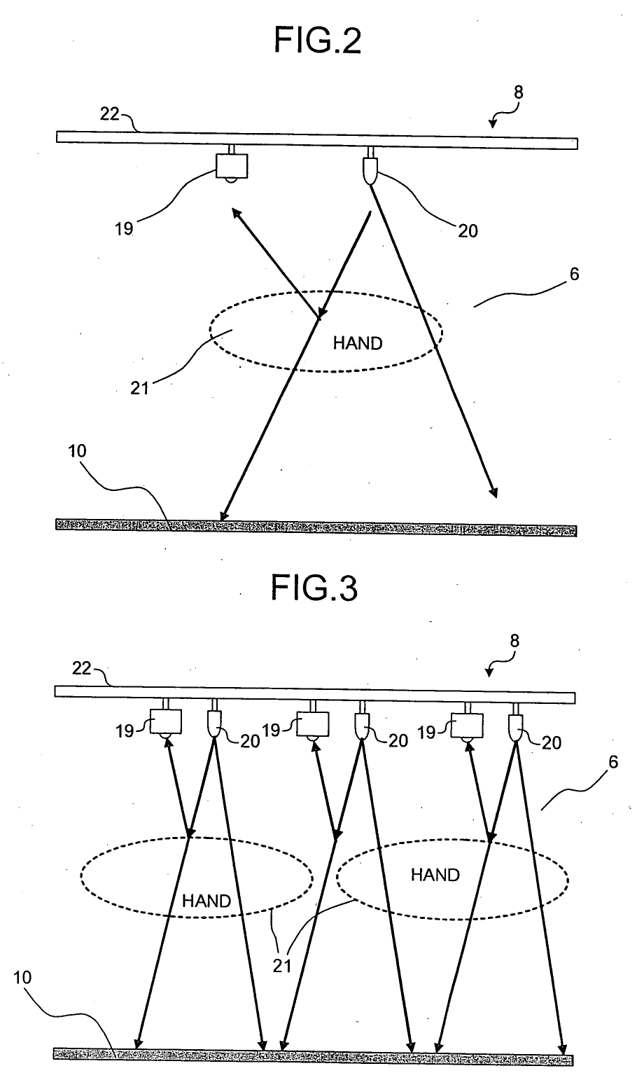

A hand drying apparatus according to a first embodiment of the present invention will be explained with reference to FIG. 1 to FIG. 3. FIG. 1 is a right side cross-section of a hand drying apparatus according to the first embodiment. FIGS. 2 and 3 are plan views of parts of a hand detector.

As shown in FIG. 1, the hand drying apparatus has a main unit box member 1 constituted of a base 5 forming a rear face outer shell and a front panel 7 forming a front face outer shell. A recessed space serving as a hand insertion portion 3 and a drying space 6 is formed on an upper side of the main unit box member 1. The recessed space is formed in an open sink shape with both sides opened and hands can be inserted.

A high pressure airflow generator 2 is assembled in the main unit box member 1, and a high pressure airflow generated by the high pressure airflow generator 2 is guided to air nozzles 4 provided on a front side wall face and a rear side wall face around the hand insertion portion 3 via air ducts 16. Fast airflows are discharged from the air nozzles 4 into the drying space 6 to blow away water on hands inserted into the hand insertion portion 3 into the drying space 6 and collect blown water in a water receiver with an inclined bottom of the recessed space, thereby pooling the collected water into a drain container 14 via a drain port 12 formed at an inclined lower end.

A drainage pipe 13 that conveys water is connected to the drain port 12. The drain container 14 with an open container structure that collects water conveyed through the drainage pipe 13 is provided. The drain container 14 can be detachable by taking-in and -out thereof in forward and backward directions. The drain container 14 is provided with a removable lid. The drain container 14 and the lid are made from chemical resistant PP, ABS resin or the like, and they can be cleaned using mild detergent, alcohol, or the like. Furthermore, water-shedding coating such as silicon-base coating or fluorine-base, hydrophilic coating such as titanium oxide coating is applied to, or anti-bacteria agent is impregnated in the wall face forming the drying space 6, so that reduction of stain adhesion or growth of bacteria can be achieved.

The high pressure airflow generator 2 is constituted of a DC brushless motor (which can be an ordinary commutator motor or an induction motor), a driving circuit that drives the DC brushless motor, and a turbofan rotated by the DC brushless motor, and it is provided just below the hand insertion portion 3 in this embodiment. Reference numeral 17 denotes a suction port of a blower and reference numeral 18 denotes an air intake port provided below the box member 1, where the air intake port 18 can suck air via a detachable air filter 15.

A hand detector 8 is provided on a rear face side of the wall face forming the drying space 6, so that presence of hands inserted into the drying space 6 via the hand insertion portion 3 is detected based on a detection signal from the hand detector 8. The hand detector 8 includes an infrared light emitter 20 and an infrared light receiver 19, a base board (not shown) on which the infrared light emitter 20 and the infrared light receiver 19 are mounted, a holder (not shown) that holds the base board, and a cover (not shown) that prevents water or the like from entering, and allows transmission of an infrared light signal. As shown in FIG. 2 or FIG. 3, the hand detector 8 is provided with a set of or plural sets of infrared light emitters 20 and infrared light receivers 19 arranged on the same wall face, and it adopts a detector constitution of a reflection type where light emitted from the infrared light emitters 20 is reflected by a hand 21 and the reflected light is detected by the infrared light receivers 19 so that the presence of hands is detected.

As shown in FIG. 2, the hand detector can be constituted of a set of infrared light emitters 20 and the infrared light receiver 19, or it can be constituted of plural sets of infrared light emitters 20 and the infrared light receiver 19, as shown in FIG. 3. The number of sets to be arranged can be determined according to a required detection range.

A detection signal from the infrared light receiver 19 is input into a control circuit (not shown) including a micro-computer, and the control circuit compares a value of the detection signal from the infrared light receiver 19 and a predetermined reference value. When the detection signal value is larger than the reference value, it is determined that hands are inserted into the drying space. When the control circuit determines that the hand are inserted, it causes a current to flow to the high pressure airflow generator 2 to discharge fast airflow from the air nozzles 4 and start an operation. The control circuit stops the operation when reflection of light from the hands is not detected and the value of the detection signal from the infrared light receiver becomes lower than the reference value.

As shown in FIG. 1 to FIG. 3, an infrared light absorber 10 whose infrared light reflectivity is smaller than that of hands and that absorbs infrared lights, is provided at at least a portion of an inner wall face forming the drying space 6 that is opposed to the infrared light emitter 20 of the hand detector 8. In this case, since the hand detector 8 is provided on a rear side inner wall face of the inner wall forming the drying space 6, the infrared light absorber 10 is provided on the inner wall face on the front side. The infrared light absorbers 10 are provided at two positions different in height in the case shown in FIG. 1, and two infrared light emitters 20 are arranged so as to be opposed to the two positions. The infrared light absorber 10 is provided at only a portion of the inner wall face forming the drying space 6 that is opposed to the infrared light emitter 20 in the case shown in FIG. 1. However, the infrared light absorber 10 can be provided on the whole inner wall face forming the drying space 6. Although constitution including one hand detector 8 and two infrared light absorbers 10 is employed in the case shown in FIG. 1, plural sets of hand detectors can be arranged in the drying space according to need, for example, in a vertical direction.

Preferably, the infrared light absorber 10 has a small reflectivity to infrared lights and a large absorptance, and it can be formed by applying a color material with dense concentration such as black, or by using a substance or a material having a surface with a deep color.

In the above constitution, reflection from the infrared light absorber 10 is reduced when hands are not inserted and infrared lights are hardly input on the infrared light receiver 19. When the hand 21 is inserted into the drying space 6, reflected light from the infrared light emitter 20 is reflected by the hand 21 to be input into the infrared light receiver 19, so that the microcomputer mounted on the control circuit detects the presence of the hand and starts an operation.

When a person other than a user of the hand drying apparatus approaches to the main unit, such a case can occur that, when the infrared light absorber 10 is not provided on the wall face in the drying space 6, infrared lights from the infrared light emitter 20 are diffusely reflected in the drying space 6, and they are output outside of the main unit, and the output infrared lights to the outside are reflected by the person, so that an improper operation is caused. When a reference value for operation start is set higher to prevent the improper operation like a conventional technique, an amount of reflection light must be increased and it results in narrowing a hand detection range. However, when the infrared light absorber 10 is provided on the wall face in the drying space 6 that is opposed to the infrared light emitter 20 like this embodiment, light is hardly output to the outside, so that a reference value applied for operation can be set low, and the hand detection range can be widened.

As a conventional hand detection system, there is also a system where an infrared light emitter and an infrared light receiver are disposed on discrete positions to be opposed to a wall face forming a drying space, the presence of hands is detected by interrupting light to the receiver, and an operation is started. In this system, it is necessary to provide hand detectors on a front side and a rear side of a main unit facing the drying space, respectively. Furthermore, it is necessary to arrange the hand detectors around the nozzles to achieve excellent detection. When the above arrangement is adopted, since it is necessary to arrange the hand detector at a position where the air duct is partially closed to have a good detecting position for stating an operation, there is a first problem that pressure loss in the air duct increases. Since it is necessary to arrange the hand detector at the uppermost position on the front side of the main unit to have a good detecting position for stopping the operation, there is a second problem that a hand insertion position must be set higher, which results in lower usability.

Since the hand detector can be arranged unitarily on either one of the front side and the rear side by adopting the hand detector based on the reflection system, a structure around the air duct can be simplified, so that cost reduction can be achieved and pressure loss in the air duct can be improved. The hand detector 8 is not required to be arranged at the front side uppermost portion 11 of the main unit; however, it can be arranged in a depth side in the drying space 6, as shown in FIG. 1, which results in improvement in usability. As shown in FIG. 3, even when a lateral size of the main unit is made longer by increasing the number of infrared light receivers 19 and infrared light emitters 20, the hand detection range can be set in the drying space 6.

In the above reflection type, if a distance between the front side wall face and the rear side wall face forming the drying space 6 is long (about 150 millimeters), since a difference in a reflection amount of infrared lights from a wall face between a time when hands are inserted and a time when hands are out can be secured sufficiently, so that provision of a hand detector of the reflection type solves the problems. However, if the distance between the wall faces is short (about 40 to 100 millimeters), since a difference in a reflection amount of infrared lights from the wall face between the time when hands are inserted and the time when hands are out cannot be secured sufficiently, so that an excellent detection sensitivity cannot be obtained.

One approach to solve this problem and obtain excellent detection sensitivity, in a hand drying apparatus where the distance of the drying space 6 is short, is to use an infrared light absorber whose reflectivity is lower than that of hands, at a portion opposed to the infrared light emitter.

To improve insertion feeling and usability when hands are inserted, it is desirable to make the space between the front panel 7 and the inner wall face forming the drying space 6 small. When hand detectors are arranged on a front face side and a rear face side, respectively, the spacing between the front panel 7 and the inner wall face becomes large due to the hand detector on the front face side, which results in deterioration of insertion feeling and usability. Therefore, the hand detector can be arranged unitarily on the rear face side of the drying space by using a combination of the hand detectors 8 of the reflection type and the infrared light absorber, so that excellent usability can be achieved.

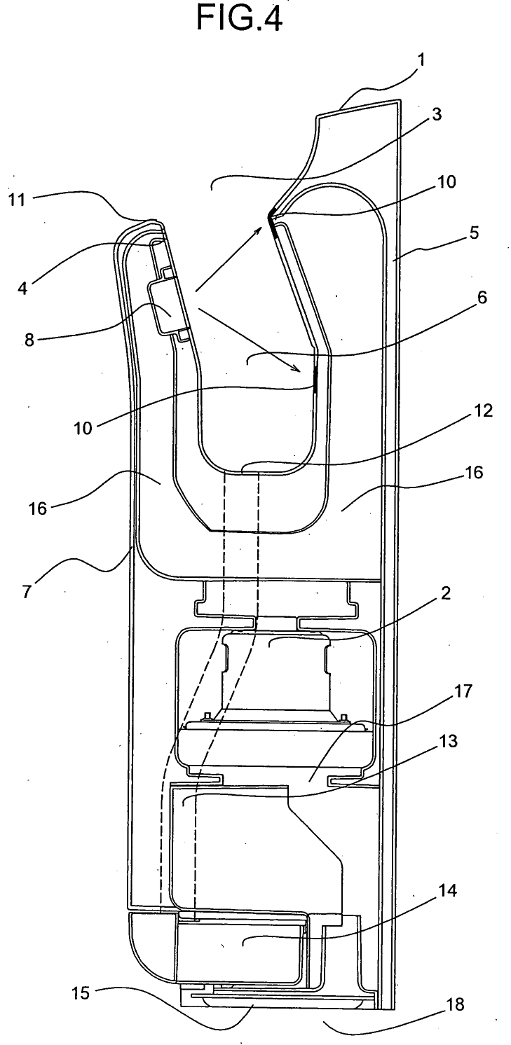

FIG. 4 depicts a variant of the hand drying apparatus according to the first embodiment. In FIG. 4, the hand detector 8 is disposed on an inner wall face on the front face side of the drying space 6. In this case, since the hand detector 8 is arranged on the inner wall face on the front face side of the drying space 6, the infrared light absorber 10 is arranged on a portion of the inner wall face forming the drying space 6 that is positioned on the rear face side.

### SECOND EMBODIMENT

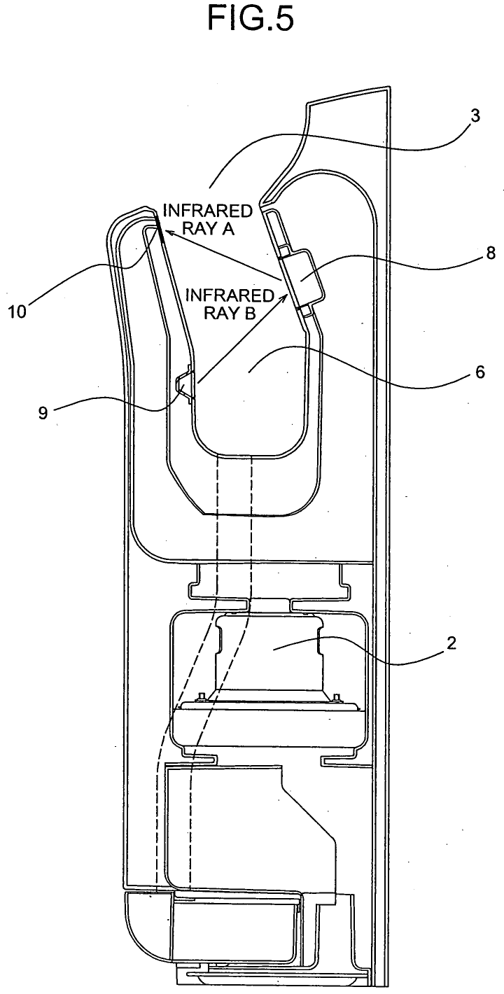

A hand drying apparatus of a second embodiment of the present invention will be explained next with reference to FIG. 5. In the second embodiment, the hand detector 8 constituted of the infrared light emitter 20 and the infrared light receiver 19 is arranged on the rear face side in the drying space 6 and an infrared light emitter 9 is provided at a front position opposed to the infrared light receiver 19 of the hand detector 8, and hands inserted near the hand insertion portion 3 in the drying space 6 is detected by a reflection type constitution including the infrared light emitter 20 and the infrared light receiver 19 built in the hand detector 8, while hands inserted into deeper in the drying space 6 is detected by a transmission type constitution including the infrared light emitter 9 and the infrared light receiver 19. Infrared rays A and B emitted from the infrared light emitter 20 and the infrared light emitter 9 and received by the infrared light receiver 19 can be discriminated properly by performing timing control or wavelength discrimination.

This case is a system where hands are detected by interrupting either one of infrared lights A and B from the infrared light emitter 20 and the infrared light emitter 9, where when hands are inserted to a point of infrared lights B, a signal is sent to the micro-computer mounted on the control circuit so that the high pressure airflow generator 2 starts operation. Since the infrared light A is emitted around the hand insertion portion 3, even when hands are positioned near the hand insertion portion 3, the operation is continued and the operation is reliably stopped when hands are out.

Thus, in the second embodiment, hands inserted into the drying space 6 are detected by cooperation of a combination of the infrared light emitter of the reflection type and the infrared light receiver, and a combination of the infrared light emitter of the transmission type and the infrared light receiver. The infrared light absorber 10 is provided at the portion opposed to the infrared light emitter of the reflection type.

While the case shown in FIG. 5 is constituted such that infrared lights generated from the infrared light emitters 20 and 9 are commonly received by the infrared light receiver 19 in the hand detector 8, an infrared light receiver that exclusively receives infrared lights generated from the infrared light emitter 9 can be separately provided on the rear face side in the drying space 6. Furthermore, such a constitution can be employed that an exclusive infrared light emitter for performing transmission type detection is provided on the wall face side (on the rear face side in FIG. 5) provided with the hand detector 8 and an infrared light receiver that receives infrared lights from the exclusive infrared light emitter is provided at a portion (on the front face side in FIG. 5) opposed to the exclusive infrared light emitter via the drying space 6.

### INDUSTRIAL APPLICABILITY

As described above, the hand drying apparatus according to the present invention is useful in a hand drying apparatus provided with a hand detector that detects inserted hands using an infrared light emitter and an infrared light receiver.

1-9. (canceled)

10. A hand drying apparatus comprising:
a high pressure airflow generator configured to generate high pressure airflow;
a nozzle that discharges the high pressure airflow generated by the high pressure airflow generator;
a drying space forming unit that has a hand insertion portion that allows insertion and pulling-out of hands and is formed with a drying space where hands inserted through the hand insertion portion is dried by the high pressure airflow discharged from the nozzle;
at least one hand detector constituted of an infrared light emitter and an infrared light receiver configured to detect hands inserted into the drying space that are arranged on the same wall face of the drying space forming unit, wherein driving of the high pressure airflow generator is controlled based on a detection signal from the hand detector; and
an infrared light absorber whose infrared light reflectivity is smaller than that of hands and absorbs infrared light, formed on at least a portion of the wall face of the drying space forming unit that is opposed to the infrared light emitter of the hand detector.

11. The hand drying apparatus according to claim 10, wherein the hand detector is provided unitarily on a rear face side of the drying space.

12. The hand drying apparatus according to claim 10, wherein color or material whose infrared light reflectivity is smaller than that of hands is used for the infrared light absorber.

13. The hand drying apparatus according to claim 11, wherein color or material whose infrared light reflectivity is smaller than that of hands is used for the infrared light absorber.

14. The hand drying apparatus according to claim 10, wherein a distance between a front face side and a rear face side of the drying space is between 40 millimeters and 100 millimeters.

15. The hand drying apparatus according to claim 11, wherein a distance between a front face side and a rear face side of the drying space is between 40 millimeters and 100 millimeters.

16. The hand drying apparatus according to claim 12, wherein a distance between a front face side and a rear face side of the drying space is between 40 millimeters and 100 millimeters.

17. The hand drying apparatus according to claim 13, wherein a distance between a front face side and a rear face side of the drying space is between 40 millimeters and 100 millimeters.

18. The hand drying apparatus according to claim 10, further comprising any one or both of an infrared light emitter and an infrared light receiver opposed to each other across the drying space, wherein hands inserted into the drying space are detected by cooperation of any one or both of the infrared light emitter and the infrared light receiver opposed to each other and the hand detector with each other.
